(19) United States
(12) Patent Application Publication
(10) Pub. No.: US 2002/0135462 A1
(43) Pub. Date: Sep. 26, 2002

(54) Method for proactive personalization and alerts to mobile devices

(76) Inventors: Michael J. Nels, Austin, TX (US); Louis V. Bona, Austin, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/015,104

(22) Filed: Dec. 11, 2001

Related U.S. Application Data
(63) Continuation of application No. 09/834,800, filed on Apr. 13, 2001.
(60) Provisional application No. 60/278,875, filed on Mar. 26, 2001.

(51) Int. Cl. H04Q 1/30

(52) U.S. Cl. 340/7.3

(57) ABSTRACT

Messages or other information may be sent to and received by a mobile communicating device consistent with triggering variables to more efficiently use the limited bandwidth and resources of the mobile communicating device. The triggering variables may be defined by a human (user of the mobile communicating device) or using an algorithm on a computer or other data processing system. By defining and using triggering variables, only relevant messages or other information may be delivered to the mobile communicating device at times determined by a user or a data processing system. The user of the mobile communicating device should be less likely to receive messages he or she does not want or messages he or she wants but at inconvenient times. The triggering variables may be used with a software agent residing within the mobile communicating device or a computer at a remote location.

### RELATED APPLICATIONS

This application claims priority under 35 U.S.C. §119(e) to U.S. Patent Application No. 60/278,875 entitled “Consumer Access Platform” by Nels et al. filed Mar. 26, 2001, and claims priority under 35 U.S.C. §120 to U.S. patent application Ser. No. 09/840,400 entitled “Method Of Searching A Database And Data Processing System Product” by Nels et al. filed Apr. 13, 2001. All applications listed in this paragraph are assigned to the current assignee hereof and are incorporated herein by reference.

### FIELD OF THE INVENTION

This invention relates in general to methods and data processing system readable media, and more particularly, to methods of sending information to and receiving information at a mobile communicating device and data processing system readable media for carrying out those methods.

### DESCRIPTION OF THE RELATED ART

Mobile devices are used for receiving messages at remote locations. Such devices suffer from a number of different problems or limitations. For example, most mobile devices have relatively limited bandwidth, which does not allow for efficiently receiving numerous messages. Receiving numerous messages may be aggravating if a notification mechanism (beeper, vibrator, or the like) is triggered when each message is received.

If all messages to a mobile device were to be delivered, a user of a mobile communicating device may have difficulty in responding to important messages. A user may need to go through all his or her messages to determine which of those messages are important to the user. Also, the user may have to look at many messages in which he or she has no interest. Further, a user may not have the ability to effectively sort messages as may be possible with a desktop wired computer.

A need exists for allowing users of mobile communicating devices to more accurately specify the types of messages they are willing to receive, times at which the users wish to receive the different types of messages, actions to be performed based on attributes of the messages, and the priorities of different messages.

### SUMMARY OF THE INVENTION

The limitations of mobile communicating devices can be reduced or eliminated using embodiments of the present invention. By defining and using triggering variables, only relevant messages or other information may be delivered to the mobile communicating devices at times determined by a user or a data processing system. Also, actions may be automatically performed by mobile communicating devices based on attributes of the messages or other information. The user of the mobile communicating device is less likely to receive messages he or she does not want or at times that are inconvenient to the user.

In one set of embodiments, a method of receiving information at a mobile communicating device can comprise accessing a first triggering variable and receiving information at the mobile communicating device consistent with the first triggering variable. In another set of embodiments, a method of sending information to a mobile communicating device can comprise accessing a first triggering variable for the mobile communicating device and sending information to the mobile communicating device consistent with the first triggering variable. The information may be sent using a wireless communicating medium.

In still other embodiments, a data processing system readable medium can have code embodied within it. The code can include instructions executable by a data processing system. The instructions may be configured to cause the data processing system to perform the methods described herein.

The foregoing general description and the following detailed description are exemplary and explanatory only and are not restrictive of the invention, as claimed.

### BRIEF DESCRIPTION OF THE DRAWINGS

The present invention is illustrated by way of example and not limitation in the accompanying figures.

FIG. 1 includes an illustration of a messaging system for a variety of mobile communicating devices.

FIG. 2 includes an illustration of a data processing system storage medium including software code.

FIGS. 3 and 4 include a process flow diagram illustrating an implementation of the messaging system.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF A PREFERRED EMBODIMENT

Reference is now made in detail to the exemplary embodiments of the invention, examples of which are illustrated in the accompanying drawings. Wherever possible, the same reference numbers will be used throughout the drawings to refer to the same or like parts (elements).

Messages or other information may be sent to or received by a mobile communicating device consistent with triggering variables. The triggering variables may be defined by a human (user of the mobile communicating device) or using an algorithm on a computer or other data processing system. By defining and using triggering variables, only relevant messages or other information may be delivered to the mobile communicating devices at times determined by a user or a data processing system. The user of the mobile communicating device may filter messages or receive the messages at times more convenient to the user.

As used herein, a relevant message or relevant information is defined as a message or other information where the attributes of the message are consistent with (meet the criteria of) the triggering variables. If any one or more of the triggering variables is unspecified, such triggering variables may, in some instances, be treated as matching the criteria set by the sender or messenger, and in other instances, be treated as not matching those criteria, depending on the system configuration. For example, a sender may provide content to a messenger with a specific attribute (e.g., information is to be provided only to medical doctors). If a demographic triggering variable related to occupation is unspecified, the message may not be delivered because the message is targeted to a relatively small audience. Alternatively, a sender may provide content to a messenger with a different attribute (e.g., information may be related to an offer that is valid for the current week). If a temporal triggering variable is not specified, the message may be delivered because the message may be of general interest and is valid for more than a couple of days. The methods are described in more detail following a hardware description of an information delivery system.

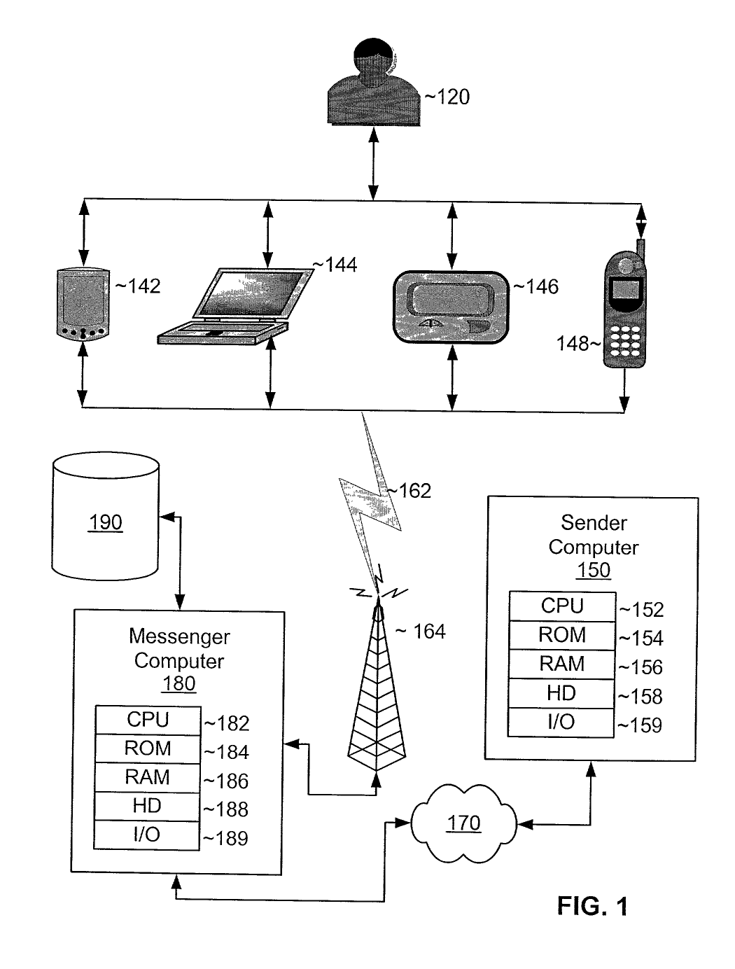

FIG. 1 includes an illustration of an information delivery system 100 that can be used for a variety of mobile communicating devices. The user 120 may use a personal digital assistant (“PDA”) 142, a laptop computer 144, a pager 146, a mobile (e.g., cellular) phone 148, or the like. Unlike a desktop computer, each of the items shown in FIG. 1 are readily portable and typically have a mass no greater than approximately 4.5 kilograms.

In one implementation, any or all of the mobile devices 142, 144, 146, and 148 may be bi-directionally coupled to a messenger computer 180 via a wireless communication medium 162 and an antenna 164. The messenger computer 180 may include a central processing unit (“CPU”) 182, a read-only memory (“ROM”) 184, a random access memory (“RAM”) 186, a hard drive (“HD”) or storage memory 188, and input/output device(s) (“I/O”) 189. The I/O 189 can include a keyboard, monitor, electronic pointing device (e.g., mouse, trackball, etc.), or the like. The messenger computer 180 may be bi-directionally coupled to a database 190 that may include many different tables or files. The database 190 may reside external to the messenger computer 180 as shown in FIG. 1 or may reside on HD 188 if the database is not too large.

The messenger computer 180 and a sender computer 150 may be bi-directionally coupled to a network 170, such as the Internet. The sender computer 150 may include a CPU 152, ROM 154, RAM 156, HD 158, and I/O 159, similar to messenger computer 180. The sender computer 150 may include messages or other information that can be sent to the user 120 at one or more of the mobile communicating devices 142, 144, 146, and 148 via the messenger computer 180.

In alternative embodiments, many different configurations are possible. For example, more or fewer computers may be used. The configurations shown in FIG. 1 or described herein are to be viewed as exemplary and not limiting.

Each of the devices 142, 144, 146, and 148 and the computers 150 and 180 are examples of data processing systems. ROM 154, RAM 156, HD 158, ROM 184, RAM 186, HD 188, and the database 190 include media that can be read by the CPU 152 or 182. Therefore, each of these types of memories includes a data processing system readable medium. These memories may be internal or external to the sender computer 150 or messenger computer 180. The mobile communicating devices 142, 144, 146, and 148 may have ROM, RAM, or other similar memories (not shown) that are also data processing system readable media.

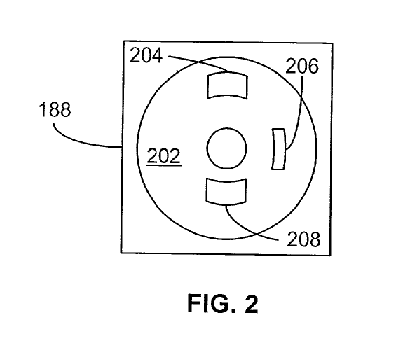

The methods described herein may be at least partially implemented in suitable software code that may reside within any one of the mobile communicating devices 142, 144, 146, or 148, ROM 154, RAM 156, HD 158, ROM 184, RAM 186, HD 188, or database 190. FIG. 2 illustrates a combination of software code elements 204, 206, and 208 that are embodied within a data processing system readable medium 202 on HD 188, for example. In addition to those types of memories previously described, the instructions in an embodiment of the present invention may be contained on a data storage device with a different data processing system readable storage medium. The instructions may be stored as software code elements on a DASD array, magnetic tape, optical storage device, CD ROM, a floppy diskette, or other appropriate data processing system readable medium or storage device.

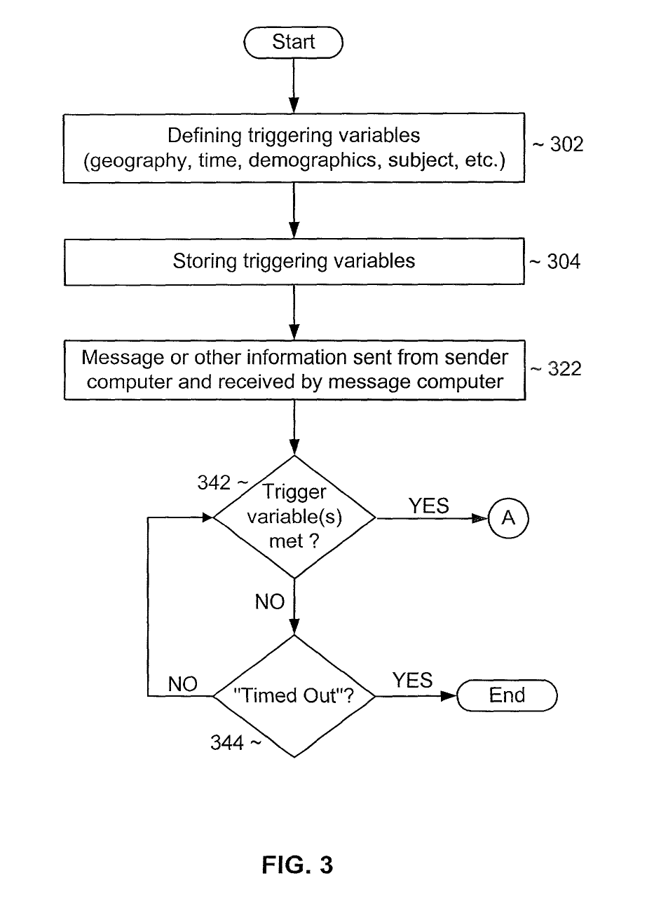

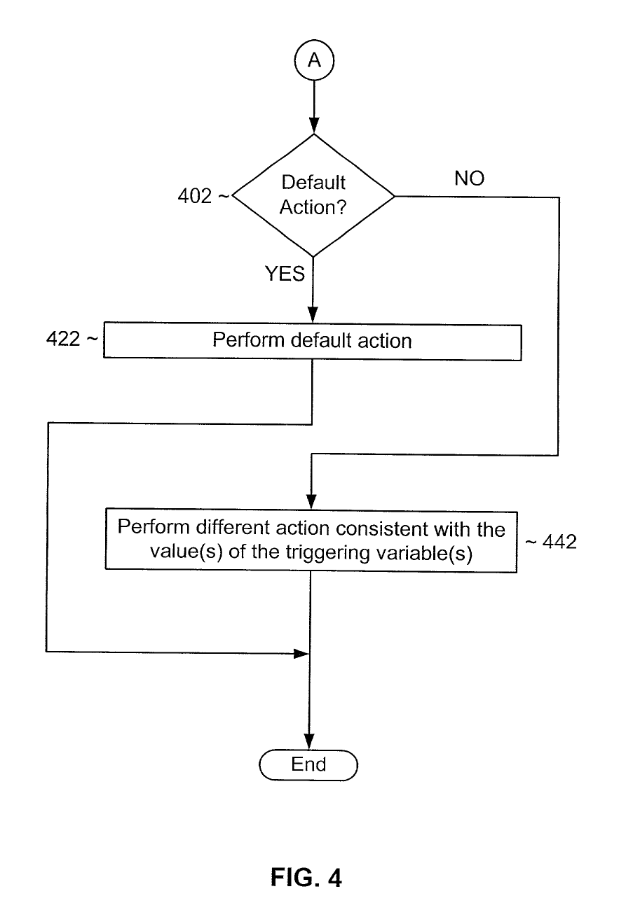

In an illustrative embodiment of the invention, the computer-executable instructions may be lines of compiled C⁺⁺, Java, or other computer programming language code. Other architectures may be used. Some or all of the functions of the sender computer 150 or messenger computer 180 may be incorporated into any or all of the devices 142, 144, 146, and 148, and vice versa. FIGS. 3-4 include illustrations, in the form of a flow diagram, of the acts that can be performed by such a software program.

Communications between the devices 142, 144, 146, 148, the messenger computer 180, and sender computer 150 can be accomplished using radio frequency, electronic, or optical signals. When a user 120 is at any of the devices 142, 144, 146, or 148, the device may convert signals to a human understandable form when receiving a communication for the user 120 and may convert input from the user 120 to appropriate signals to be used by the devices 142, 144, 146, 148, the messenger computer 180, or sender computer 150.

As illustrated in FIG. 1, the system 100 may be used primarily in sending communications from a sender computer 150 through a messenger computer 180 to any or all of the mobile communicating devices 142, 144, 146, and 148. Signals may be sent from any of the communicating devices 142, 144, 146, or 148 to the messenger computer 180. Such signals may include information regarding triggering variables for that specific communicating device if the triggering variables are stored within the communicating device. The triggering variables can be used to determine what or when messages or other information are to be sent from messenger computer 180 to the communicating devices.

FIGS. 3 and 4 include a flow diagram that illustrates how the system 100 may be used. The method can comprise defining triggering variables as illustrated in block 302 of FIG. 3. These triggering variables may be related to geography, time, demographics, subject, or the like. The triggering variables may be defined by user 120 or, at least in part, using a software agent that may reside on the wireless mobile communicating device 142, 144, 146, or 148. Alternatively, the software agent with some or all of the triggering variables may reside on messenger computer 180, sender computer 150, or database 190. Note that user 120 may have more than one of the mobile communicating devices 142, 144, 146, and 148. The different types of mobile communicating devices may have different values for the triggering variables to optimize the performance from the standpoint of the user 120.

The geographic variable can correspond to a coverage area. For example, user 120 may specify that a size of a coverage area for relevant messages or other information includes a circle having a 30-kilometer radius. A different radius may be used as determined by the user 120. As communicating device 142, 144, 146, or 148 is moved from a first location to a second location, the coverage area can move with user 120. In such an instance, the coverage area can remain substantially the same size, even though the location changes. For example, user 120 may be traveling several hundred kilometers. Although the size of the coverage area before and after travel is approximately 94 square kilometers, the location of the coverage area has moved from a first area to a second area, which is now the area of interest for user 120. Note that the first and second areas may be spaced apart (as in the prior example) or partially overlap each other; however, the center point of the first area and the center point of the second area are at different locations for both situations (spaced apart or partial overlap).

The manner for changing the geographic variable can be performed in a number of different ways. The user 120 may manually change the location of the coverage area. In one embodiment, user 120 may input a zip code or postal code at the location at which the person currently is located or will soon be located. Alternatively, a telephone area code (or country code) and local telephone exchange may be used. In another embodiment, a signal may be automatically generated by the mobile communicating device 142, 144, 146, or 148 or by an external source (e.g., global positioning satellites, cellular phone transmission towers, or the like). Such automatic signal generation may be performed without any human intervention. Regardless of how a location and size of a coverage area is determined, the coverage area can move with the device.

Temporal variables can be used to determine when a message will be sent by the messenger computer 180 or received by a communicating device 142, 144, 146, or 148. Some of these devices, particularly devices 146 and 148, may have a limited bandwidth and memory size. These devices may be used in communicating in emergency or more important situations during certain times of the day.

For example, a person working on a manufacturing assembly line may need to be paged quickly from 7:00 a.m. to 7:00 p.m. on Monday through Friday. This person may have his or her pager 146 or cellular phone 148 off at all other times. If information is to be sent to user 120 outside those times and would only be effective during those off times, user 120 may not need to know about that information and probably would not desire having it. These temporal triggering variables allow some extraneous information to be filtered, and therefore, the user receives more pertinent information upon which he or she may act.

Other types of temporal variables for user 120 may include a specified receiving time for messages or a queuing limit. Regarding the former, the user 120 may specify that all less important (not urgent) messages or other information are to be delivered at 6 p.m. each day. Regarding the latter, messages or other information may accumulate within a queue in database 190, RAM 184, or HD 188 and be delivered when the number of messages within the queue reaches a specified level (e.g., five messages). Once the limit is reached, the messages may be sent from the messenger computer 180 and received by mobile communicating device 142, 144, 146, or 148 at that time or during the next available time if the mobile communicating device 142, 144, 146, or 148 is not to receive messages at the time when the queue triggering number is met. Clearly, these examples are meant to illustrate and not limit the present invention.

Demographics may include gender, education level, occupation, income, age, or the like. The demographics may be used in determining what information the person is to receive. For example, a man probably does not need to know about special offers regarding women's lingerie. Likewise, women may not be interested that a store selling men's business suits is having a sale. The information may not be useful to user 120 and may be filtered, thereby, leaving more relevant messages for user 120.

Subject can also be used as a triggering variable. User 120 may be interested in financial information and scientific journals but may not be interested in sports or cooking. If user 120 has interest in a limited number of subjects, user 120 can effectively filter messages and other information regarding those subjects. Given the limited bandwidth and memory constraints of some mobile devices, being able to filter unwanted or undesired information can prove valuable. The user 120 can more effectively use his or her mobile communicating device, particularly in the case of the pager 146 or cellular phone 148.

Additionally, the user 120 may have different actions (functions) performed depending on the subject. For example, if user 120 is interested in business or financial information, he or she may want to receive that information when it first becomes available. However, information from scientific journals may not be quite as time sensitive. In this situation, user 120 may want to delay receiving the scientific journal information until a later time. For example, user 120 may specify that the financial or business information should be received at any time, but information from a technical journal should be received only between 5:00 p.m. to 7:00 p.m. Monday through Friday and any time on weekends. In this manner, more time-sensitive information gets to user 120 quicker, but he or she can also receive the other information in which the user 120 has interest that is not quite as time sensitive.

The method can further include storing the triggering variables as shown in block 304 in FIG. 3. The triggering variables may be stored within memory of device 142, 144, 146, or 148 or may be stored at the messenger computer 180, the sender computer 150, or the database 190. In one example, a temporal triggering variable may be used in aggregating messages within a queue before sending them to the mobile communicating device 142, 144, 146, or 148 during a predetermined time period.

An optional act can be performed where a message or other information is sent from sender computer 150 and received by messenger computer 180 as illustrated in block 322. Alternatively, the message or other information may originate from an operator of the messenger computer 180 instead of or in addition to the sender computer 150. Regardless of the originating source, the message or other information may include attributes that the messenger computer 180 may store with the message or other information within database 190. These attributes may include key words (subject-related attributes), targeted demographics for the recipient of the message, a geographic location to which the message is associated, temporal information, or the like. Some of this information may be important to a store or other business that is offering a special offer to selected customers (demographic variables) for a limited time (temporal variables).

In decision diamond 342, a determination can be made whether the triggering variable(s) are met. For example, if the message or other information at messenger computer 180 or database 190 includes certain attribute(s) that match the triggering variable(s) for user 120, the method proceeds to circle “A,” which is continued on FIG. 4 and will be described later.

Alternatively, if the triggering variable(s) have not been met, the method can optionally proceed to decision diamond 344 in FIG. 3. First, a determination is made whether the message or other information has “timed out.” By timing out, it is meant that either a number of tries have been unsuccessfully attempted or that time has lapsed where the information should no longer be sent to user 120. Temporal triggering variables are usually the target for timing out. For example, if user 120 has his or her communicating device off during the weekend, and a message regarding a special offer is sent early Saturday that would be effective only that weekend, it does not make sense to send the message to user 120. In this instance, there is no reasonable likelihood of getting the message to user 120 for him or her to act on the special offer. A “timed out” condition occurs. In this situation, the method would end and no further attempts would be made by the messenger computer 180 to send or by the mobile communicating device 142, 144, 146, or 148 to receive that message.

However, if the message is sent in the evening hours during a weekday for that same special offer available during the upcoming weekend, it still may be sent to user 120 if user 120 has his or her communicating device active and ready to receive the information from 7:00 a.m. to 7:00 p.m. during the latter portion of the week. In this instance, when mobile communicating device 142, 144, 146, or 148 becomes active (if not already active and ready to receive messages), its software agent may notify the messenger computer 180 that it is now ready to accept messages. Messenger computer 180 may determine that there is an appropriate message that can be sent to the mobile communicating device 142, 144, 146, or 148. In this instance, the “timed out” condition would not occur, and the triggering variable can be met and proceed to circle “A.”

The maximum number of attempts or time between checking to determine if the triggering variable(s) have been met can be defined by the user 120 or an operator at computer 150 or 180. The number of attempts may be one, ten, one hundred, or even more. The time between checking may be five minutes, one hour, six hours, a day, a week, or the like. In some instances the number of attempts may depend on the length of the time between checking; however, skilled artisans should be capable of determining the number after reading this specification. The parameter(s) for maximum attempts or time between checking may be stored on the mobile communicating device 142, 144, 146, HD 158 or 188, or database 190.

In some instances, the triggering variables may be unlikely to change over a one-month time period. For example, demographic and subject triggering variables are unlikely to change at a relatively higher frequency. If a demographic or subject trigger is not met on the first attempt, no additional attempts may be tried. In this instance (not shown in FIG. 3), the “NO” branch of the diamond 342 would go directly to “End” and bypass the decision diamond 344.

Turning to FIG. 4, actions performed may depend on the value of the triggering variable. In decision diamond 402, a determination can be made whether a default action is to be performed. If yes, the method may comprise performing a default action as illustrated in block 422. If no, the method may comprise performing a different action consistent with the value(s) of the triggering variable(s) as shown in block 442.

In one non-limiting example, the triggering variable may be a subject. Returning to a prior example, the user 120 may want to receive business information as soon as possible but may want to receive technical information only later in the day. In this situation, the software agent may determine if the subject is technical information. If not, the default action may be performed and include displaying the message or notifying the user 120 at the mobile communicating device 142, 144, 146, or 148 as soon as the message arrives. For technical information, it may accumulate in a queue or otherwise be delayed before the user 120 would be displayed or notified regarding the message. Alternatively, the software agent may store the information in one of many different folders on the mobile communicating device 142, 144, 146, or 148 depending on the value of the attribute and its corresponding triggering variable.

Other combinations of variables may be used. For example, all four of the triggering variables (time, geography, demographics, and subject) may need to be met in order for a message to be sent to the mobile communicating device 142, 144, 146, or 148. Alternatively, only one or some other combination less than all of the triggering variables may need to be satisfied in order for a message or other information to be transmitted to mobile communicating device 142, 144, 146, or 148. Other triggering variables may be used in place of or in conjunction with any or all of the triggering variables described. In still another alternative embodiment, the method may proceed from block 322 in FIG. 3 to decision diamond 402 in FIG. 4 and not perform the determination acts within diamonds 342 and 344 shown in FIG. 3.

In some embodiments, a progressive sieve or other filtering mechanism may be used. The progressive sieve or other filtering mechanism may be part of a software agent on the messenger computer 180, any one or more of the mobile communicating devices 142, 144, 146, and 148, or any combination thereof.

For example, the sender computer 150 may send a message or other information to the messenger computer 180. An attribute of that message or other information may be of a type that is least likely to be met by a corresponding triggering variable of the user 120 or other users (not shown) of system 100. When the software agent for the messenger computer 180 determines which users are to receive the message or other information, the messenger computer 180 may search for users using the triggering variable that is least likely to be met to give a first set of intermediate results. That first set of intermediate results would be searched using a different triggering variable that is the next least likely to be met, and so forth.

Whereas the software agent in the messenger computer 180 may search in an order based on user triggering variables least likely to be met, the software agent in the mobile communicating device 142, 144, 146, or 148 may search in an order based on attributes of messages at the messenger computer 180. The software agent for the mobile communicating device 142, 144, 146, or 148 may search for messages with an attribute least likely to be met to give a first set of intermediate results. That first set of intermediate results would be searched using a different attribute that is the next least likely to be met, and so forth.

The concepts of the three preceding paragraphs may be better understood with specific examples. A bar or other entertainment establishment may be offering a drink special from midnight to 1:00 a.m. The sender computer 150 may send the message to messenger computer 180 at approximately 8:00 p.m. (approximately four hours before the drink special). After reviewing database 190 regarding triggering variables from users, the messenger software agent within messenger computer 180 determines that many of the mobile communicating devices would be asleep or most of the users that would be receiving the message would not act on the drink special. In this situation, most of the mobile communicating devices 142, 144, 146, and 148 will probably not meet the temporal attribute of the message. Therefore, a software agent within the messenger computer 180 would first search for mobile communicating devices 142, 144, 146, and 148 using their temporal triggering variables and retrieve the identifiers for the mobile communicating devices 142, 144, 146, and 148 meeting the temporal limitation.

Further searching would only be performed for those mobile communicating devices that met the first search criterion (temporal triggering variable). Subsequent searches on that subset of mobile communicating devices can be performed using other criteria, such as geographic location if that is the next least likely to be met, followed by demographics, followed by subject matter if that triggering variable would be the most likely attribute to be met. In this manner, a messenger computer 180 can be programmed to more efficiently reduce the number of mobile communicating devices 142, 144, 146, and 148 for subsequent searches. In this manner, the computer resources are more efficiently managed.

If the searching is performed by a software agent residing within any of the mobile communicating devices 142, 144, 146, or 148, the manner of searching would be similar, but the order of searching attributes of the messages may be different. Assume that the user 120 is only interested in software subjects, receives messages from 7 a.m. to 7 p.m., and most messages sent by the messenger computer 180 are not related to software subjects. The software agent within mobile communicating device 142, 144, 146, or 148 may search for a subject attribute of the messages first. The drink special (from the prior example) would be screened on the first pass. Note that messages may be searched for the temporal triggering variable last because most messages at the messenger computer 180 may be received and acted upon within that 12-hour time frame (7 a.m. to 7 p.m.), although that would not be true in this particular example.

The order of searching used by the messenger computer 180 or the mobile communicating devices can be determined by a human or may be “learned” by the computer 180 or the mobile communicating device 142, 144, 146, or 148 using a conventional neural network or other self-learning technique without any human intervention. In this manner, a messenger computer 180 or mobile communicating device 142, 144, 146, or 148 can be programmed to more efficiently use limited resources.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of receiving information at a mobile communicating device comprising:
accessing a first triggering variable; and
receiving information at the mobile communicating device consistent with the first triggering variable.

2. The method of claim 1, wherein the first triggering variable is selected from a group consisting of a geographic variable, a temporal variable, a demographic variable, and a subject variable.

3. The method of claim 1, wherein accessing further comprises accessing a second triggering variable, a third triggering variable, and a fourth triggering variable, wherein:
the first triggering variable includes a geographic variable;
the second triggering variable includes a temporal variable;
the third triggering variable includes a demographic variable; and
the fourth triggering variable includes a subject variable.

4. The method of claim 1, further comprising:
determining a value of the first triggering variable;
performing a first act if the value meets a first criterion; and
performing a second act, which is different from the first act, if the value does not meet the first criterion.

5. The method of claim 1, further comprising:
moving the mobile communicating device; and
automatically moving a coverage area, wherein:
the first triggering variable includes a size of the coverage area;
before moving the mobile communicating device, the coverage area occupies a first area;
after moving the mobile communicating device, the coverage area occupies a second area;
a size of the first area and a size of the second area are substantially equal to the size of the coverage area; and
a center of the first area and a center of the second area are at different locations.

6. The method of claim 1, wherein the first triggering variable includes a temporal variable that specifies when the information is allowed to be received.

7. The method of claim 1, wherein receiving the information is performed using a wireless communicating medium.

8. The method of claim 1, further comprising:
accessing a second triggering variable before accessing the first triggering variable;
determining that a first attribute of the information is less likely to be met compared to a second attribute of the information, wherein the first attribute corresponds to the first triggering variable and the second attribute corresponds to the second triggering variable;
searching a repository for the first attribute to generate a first set of results; and
searching the first set of results for the second attribute to generate a second set of results that includes the information.

9. A method of sending information to a mobile communicating device comprising:
accessing a first triggering variable for the mobile communicating device; and
sending information to the mobile communicating device consistent with the first triggering variable, wherein the information is sent using a wireless communicating medium.

10. The method of claim 9, wherein the first triggering variable is selected from a group consisting of a geographic variable, a temporal variable, a demographic variable, and a subject variable.

11. The method of claim 9, wherein accessing further comprises accessing a second triggering variable for the mobile communicating device, a third triggering variable for the mobile communicating device, and a fourth triggering variable for the mobile communicating device, wherein:
the first triggering variable includes a geographic variable;
the second triggering variable includes a temporal variable;
the third triggering variable includes a demographic variable; and
the fourth triggering variable includes a subject variable.

12. The method of claim 9, further comprising receiving a signal that the mobile communicating device has been moved from a first area to a second area, wherein:
the signal has been generated without any human intervention;
the information is relevant to the second area but not relevant the first area; and
sending the information is performed after receiving the signal.

13. The method of claim 9, wherein the triggering variable includes a temporal variable that specifies when the information is to be sent to the mobile communicating device.

14. The method of claim 9, further comprising:
accessing a second triggering variable before accessing the first triggering variable;
determining that the first triggering variable is less likely to be met compared to the second triggering variable;
searching a repository for the first triggering variable to generate a first set of results; and
searching the first set of results for the second triggering variable to generate a second set of results that includes the information.

15. A data processing system readable medium having code embodied therein, the code including instructions executable by a data processing system, wherein the instructions are configured to cause the data processing system to perform a method of receiving information at a mobile communicating device, wherein the method comprises:
accessing a first triggering variable; and
receiving information at the mobile communicating device consistent with the first triggering variable.

16. The data processing system readable medium of claim 15, wherein the first triggering variable is selected from a group consisting of a geographic variable, a temporal variable, a demographic variable, and a subject variable.

17. The data processing system readable medium of claim 15, wherein accessing further comprises accessing a second triggering variable, a third triggering variable, and a fourth triggering variable, wherein:
the first triggering variable includes a geographic variable;
the second triggering variable includes a temporal variable;
the third triggering variable includes a demographic variable; and
the fourth triggering variable includes a subject variable.

18. The data processing system readable medium of claim 15, wherein the method further comprises:
determining a value of the first triggering variable;
performing a first act if the value meets a first criterion; and
performing a second act, which is different from the first act, if the value does not meet the first criterion.

19. The data processing system readable medium of claim 15, wherein the method further comprises:
moving the mobile communicating device; and
automatically moving a coverage area, wherein:
the first triggering variable includes a size of the coverage area;
before moving the mobile communicating device, the coverage area occupies a first area;
after moving the mobile communicating device, the coverage area occupies a second area;
a size of the first area and a size of the second area are substantially equal to the size of the coverage area; and
a center of the first area and a center of the second area are at different locations.

20. The data processing system readable medium of claim 15, wherein the first triggering variable includes a temporal variable that specifies when the information is allowed to be received.

21. The data processing system readable medium of claim 15, wherein receiving the information is performed using a wireless communicating medium.

22. The data processing system readable medium of claim 15, wherein the method further comprises:
accessing a second triggering variable before accessing the first triggering variable;
determining that a first attribute of the information is less likely to be met compared to a second attribute of the information, wherein the first attribute corresponds to the first triggering variable and the second attribute corresponds to the second triggering variable;
searching a repository for the first attribute to generate a first set of results; and
searching the first set of results for the second attribute to generate a second set of results that includes the information.

23. A data processing system readable medium having code embodied therein, the code including instructions executable by a data processing system, wherein the instructions are configured to cause the data processing system to perform a method of sending information to a mobile communicating device, wherein the method comprises:
accessing a first triggering variable; and
sending information to the communicating device consistent with the first triggering variable, wherein the information is sent using a wireless communicating medium.

24. The data processing system readable medium of claim 23, wherein the first triggering variable is selected from a group consisting of a geographic variable, a temporal variable, a demographic variable, and a subject variable.

25. The data processing system readable medium of claim 23, wherein accessing further comprises accessing a second triggering variable for the mobile communicating device, a third triggering variable for the mobile communicating device, and a fourth triggering variable for the mobile communicating device, wherein:
the first triggering variable includes a geographic variable;
the second triggering variable includes a temporal variable;
the third triggering variable includes a demographic variable; and
the fourth triggering variable includes a subject variable.

26. The data processing system readable medium of claim 23, wherein the method further comprises receiving a signal that the mobile communicating device has been moved from a first area to a second area, wherein:
the signal has been generated without any human intervention;
the information is relevant to the second area but not the first area; and
sending the information is performed after receiving the signal.

27. The data processing system readable medium of claim 23, wherein the first triggering variable includes a temporal variable that specifies when the information is to be sent to the mobile communicating device.

28. The data processing system readable medium of claim 23, wherein the method further comprises:
accessing a second triggering variable before accessing the first triggering variable;
determining that the first triggering variable is less likely to be met compared to the second triggering variable;
searching a repository for the first triggering variable to generate a first set of results; and
searching the first set of results for the second triggering variable to generate a second set of results that includes the information.
